(19) United States
(12) Patent Application Publication
(10) Pub. No.: US 2024/0397491 A1
(43) Pub. Date: Nov. 28, 2024

(54) SYSTEMS AND METHODS FOR ACQUIRING SSB MISSED DUE TO LISTEN BEFORE TALK (LBT) FAILURES IN 5G NEW RADIO NETWORKS OPERATING IN UNLICENSED BANDS (NR U)

(71) Applicant: INTERDIGITAL PATENT HOLDINGS, INC., Wilmington (DE)

(72) Inventors: Nazli Khan Beigi, Longueuil (CA); Young Woo Kwak, Woodbury, NY (US); Moon IL Lee, Melville, NY (US); Paul Marinier, Brossard (CA); Janet Stern-Berkowitz, Little Neck, NY (US)

(73) Assignee: INTERDIGITAL PATENT HOLDINGS, INC., Wilmington (DE)

(21) Appl. No.: 18/695,527

(22) PCT Filed: Sep. 28, 2022
(86) PCT No.: PCT/US2022/045092

§ 371 Date: Mar. 26, 2024

Related U.S. Application Data
(60) Provisional application No. 63/249,372, filed on Sep. 28, 2021.

(51) Int. Cl. H04W 72/0446; H04W 56/00

(52) U.S. Cl. CPC H04W 72/0446; H04W 56/0015

(57) ABSTRACT

A method and apparatus for receiving synchronization signal block (SSB) at a WTRU is disclosed. The WTRU receives a candidate SSB in a set of symbols in a slot. Then the WTRU receives an indication of a mode of association between candidate SSB positions and candidate SSB index. Next the WTRU determines a candidate SSB index associated with the candidate SSB. Then the WTRU determines a symbol number of a symbol in the set of symbols and a slot number of the slot based on the candidate SSB index and the indicated mode of association. And, then the WTRU receives a PDCCH transmission using a timing determined based on the determined symbol number and slot number. In some embodiments, the indicated mode of association may be either a first mode or a second mode.

### CROSS-REFERENCE TO RELATED APPLICATIONS

This application claims the benefit of U.S. Provisional Application No. 63/249,372, filed Sep. 28, 2021, the contents of which are incorporated herein by reference.

### BACKGROUND

In wireless networks, a wireless transmit receive unit (WTRU) may gain access to resource unit allocations by joining a cell. To join a cell the WTRU performs an initial procedure to synchronize with the cell by acquiring and decoding a synchronization signal block (SSB) transmitted by a gNB. As part of the initial procedure the WTRU communicates with the gNB on a frequency indicated to the WTRU as corresponding to the SSB. If the indicated frequency lies within an unlicensed transmission channel, the WTRU is required to perform a Listen before Talk (LBT) procedure before it can transmit on the indicated frequency. If the LBT procedure determines the channel is currently use, the WTRU cannot transmit on the channel until the channel is clear. That may be too late to acquire the SSB. In that case an LBT misses the SSB and an LBT failure is said to have occurred. Therefore, systems and methods by which the WTRU can acquire the missed SSB are needed. Accordingly, embodiments disclosed and described herein provide systems and methods for acquiring SSB missed due to LBT failures in networks operating in unlicensed bands.

### SUMMARY

A method and WTRU for receiving synchronization signal block (SSB) are disclosed. The WTRU receives a candidate SSB in a set of symbols in a slot. Then the WTRU receives an indication of a mode of association between candidate SSB positions and candidate SSB index. Next the WTRU determines a candidate SSB index associated with the candidate SSB. Then the WTRU determines a symbol number of a symbol in the set of symbols and a slot number of the slot based on the candidate SSB index and the indicated mode of association. And, then the WTRU receives a PDCCH transmission using a timing determined based on the determined symbol number and slot number. In some embodiments, the indicated mode of association may be either a first mode or a second mode. The slot number may be a first slot number when the mode of association is a first mode of association, and the slot number may be a second slot number when the mode of association is the second mode of association. The mode of association may be a prioritization mode, where SSBs at the beginning of each SSB candidate bundle are prioritized, and the mode of association may be a hybrid model based on priority and first missed-first served. The indication may be received in a master information block (MIB).

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates transmission of missed SSB blocks (due to the LBT failure) in new candidate SSB positions;

FIG. 3 illustrates a Case A SSB pattern for a 15 kHz SCS according to embodiments;

FIG. 4 illustrates a Case D structure for a 120 kHz SCS, in a half frame according to embodiments;

FIG. 5 illustrates an improved synchronization signal block (SSB) structural arrangement by which a number of SSB candidate indexes is increased according to embodiments;

FIG. 6 illustrates a Case D structure for a 120 kHz SCS, in a half frame according to embodiments;

FIG. 7 illustrates an SSB pattern using 8 available gap slots within the SSB burst as the new candidate SSB positions based on prioritized association according to embodiments;

FIG. 8 illustrates an SSB pattern using the 8 available gap slots within the SSB burst as the new candidate SSB positions based on hybrid positioning of the candidate SS/PBCH block positions according to embodiments;

FIG. 9 illustrates an SSB pattern using the 8 available gap slots within the SSB burst as the new candidate SSB positions according to embodiments;

FIG. 10 shows an example flow diagram for determining whether to operating in a mode 1, or mode 2 solution;

FIG. 11 shows an MIB including example operating parameters that may be included in the second set of PBCH/MIB payload bits according to embodiments; and

FIG. 12 shows example contents of PDCCH-ConfigSIB1 according to embodiments.

### DETAILED DESCRIPTION

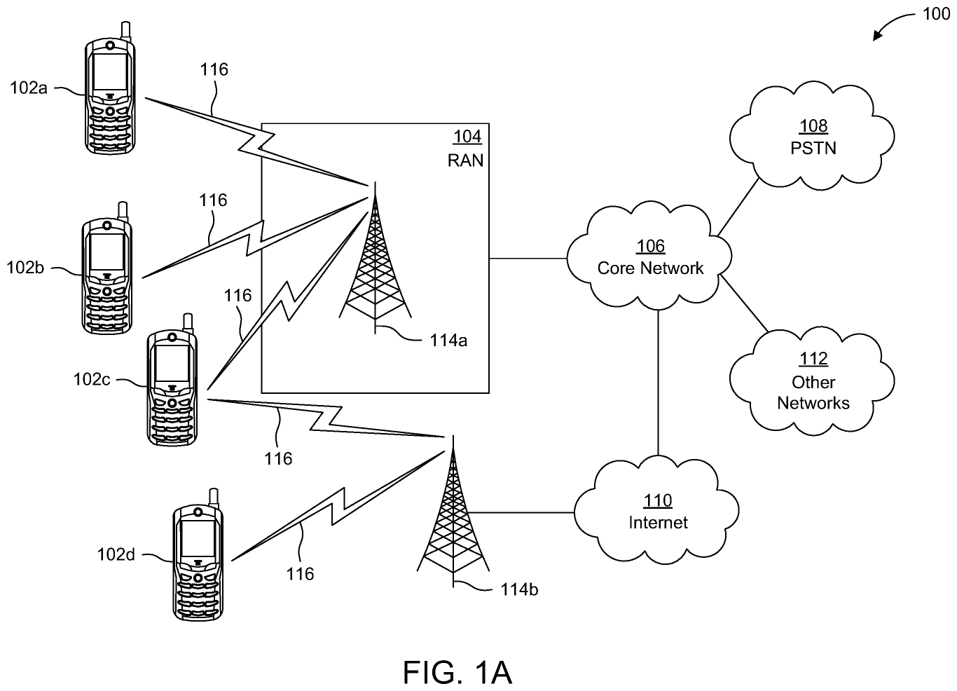

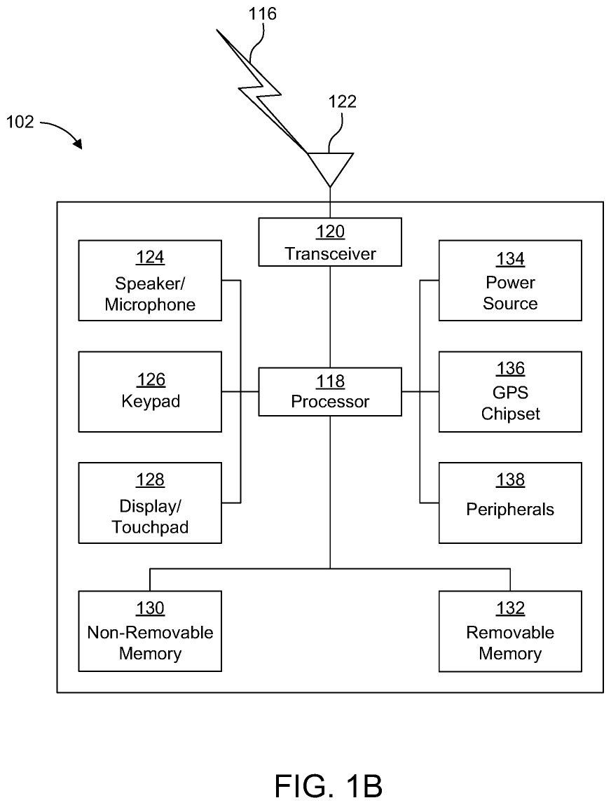

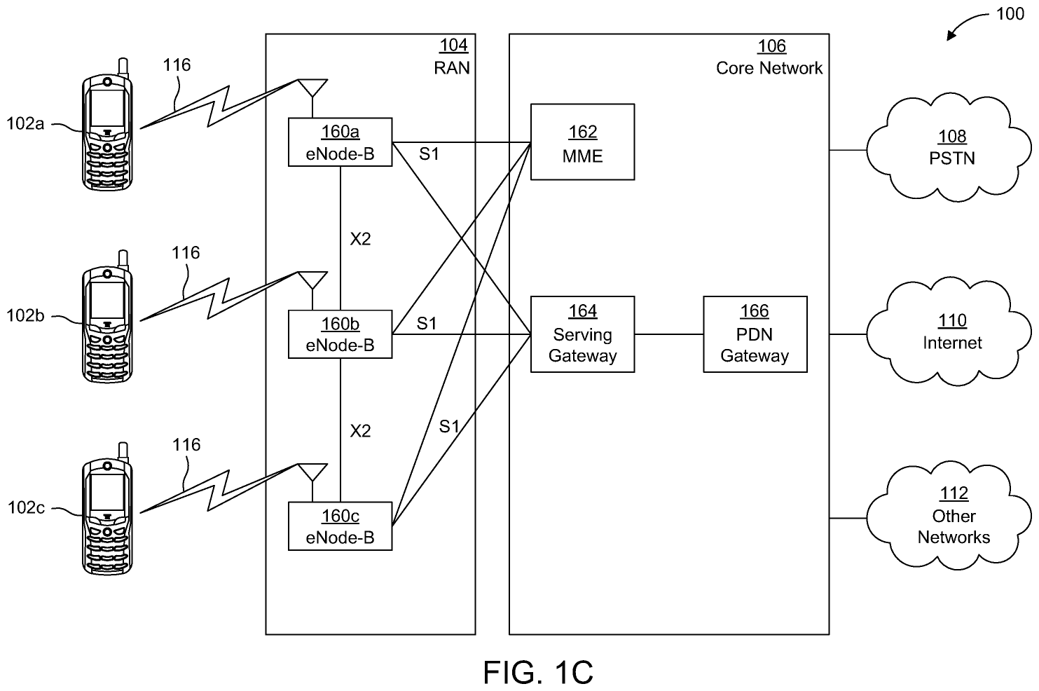

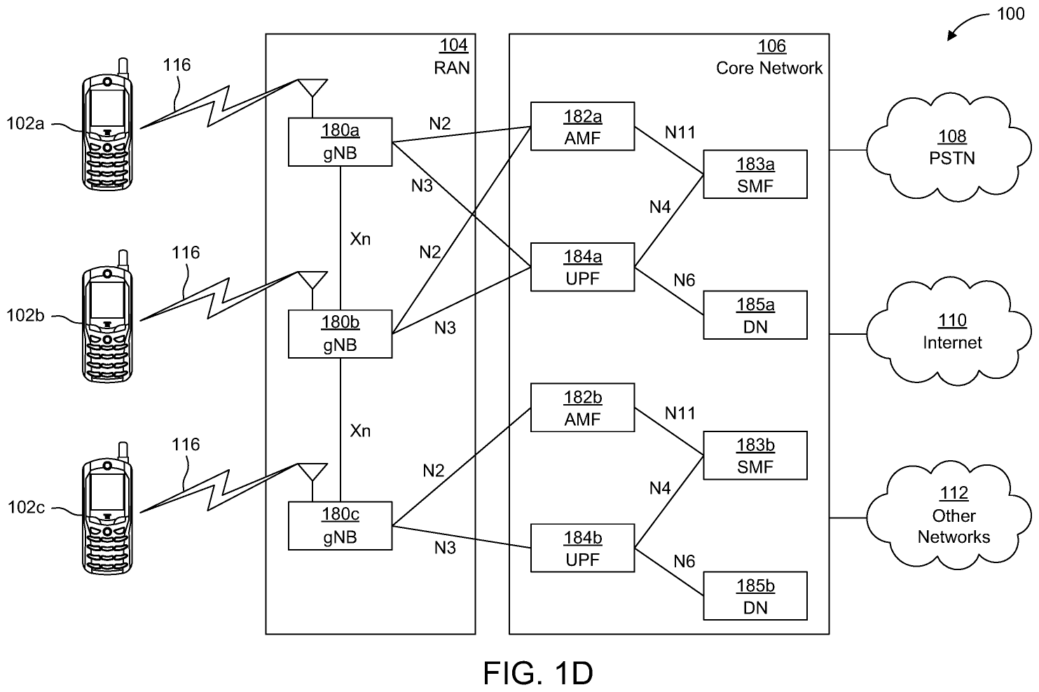

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data. It should be understood that the embodiments of FIGS. 1A-1D can be configured to perform the methods described in more detail below. Table 1 below lists terms, abbreviations and acronyms as defined herein.

TABLE 1

| | |
|---|---|
| Δf | Sub-carrier spacing |
| gNB | NR NodeB |
| AP | Aperiodic |
| BFR | Beam Failure Recovery |
| BFD-RS | Beam Failure Detection-Reference Signal |
| BLER | Block Error Rate |
| BWP | Bandwidth Part |
| CA | Carrier Aggregation |
| CB | Contention-Based (e.g. access, channel, resource) |
| CCA | Clear Channel Assessment |
| CDM | Code Division Multiplexing |
| CG | Cell Group |
| CoMP | Coordinated Multi-Point transmission/reception |
| COT | Channel Occupancy Time |
| CP | Cyclic Prefix |
| CPE | Common Phase Error |
| CP-OFDM | Conventional OFDM (relying on cyclic prefix) |
| CQI | Channel Quality Indicator |
| CN | Core Network (e.g. LTE packet core or NR core) |
| CRC | Cyclic Redundancy Check |
| CSI | Channel State Information |
| CSI-RS | Channel State Information-Reference Signal |
| CU | Central Unit |
| D2D | Device to Device transmissions (e.g. LTE Sidelink) |
| DBTW | Discovery Burst Transmission Window |
| DC | Dual Connectivity |
| DCI | Downlink Control Information |
| DL | Downlink |
| DM-RS | Demodulation Reference Signal |
| DRB | Data Radio Bearer |
| DU | Distributed Unit |
| EN-DC | E-UTRA - NR Dual Connectivity |
| EPC | Evolved Packet Core |
| FD-CDM | Frequency Domain-Code Division Multiplexing |
| FDD | Frequency Division Duplexing |
| FDM | Frequency Division Multiplexing |
| ICI | Inter-Cell Interference |
| ICIC | Inter-Cell Interference Cancellation |
| IP | Internet Protocol |
| LBT | Listen-Before-Talk |
| LCH | Logical Channel |
| LCID | Logical Channel Identity |
| LCP | Logical Channel Prioritization |
| LLC | Low Latency Communications |
| LTE | Long Term Evolution e.g. from 3GPP LTE R8 and up |
| MAC | Medium Access Control |
| MAC CE | Medium Access Control Control Element |
| NACK | Negative ACK |
| MBMS | Multimedia Broadcast Multicast System |
| MCG | Master Cell Group |
| MCS | Modulation and Coding Scheme |
| MIMO | Multiple Input Multiple Output |
| MTC | Machine-Type Communications |
| MR-DC | Multi-RAT Dual Connectivity |
| NAS | Non-Access Stratum |
| NCB-RS | New candidate beam-Reference Signal |
| NE-DC | NR-RAN - E-UTRA Dual Connectivity |
| NR | New Radio |
| NR-DC | Dual Connectivity with |
| OFDM | Orthogonal Frequency-Division Multiplexing |
| OOB | Out-Of-Band (emissions) |
| P_{cmax} | Total available WTRU power in a given transmission |
| | interval |
| Pcell | Primary cell of Master Cell Group |
| PCG | Primary Cell Group |
| PDU | Protocol Data Unit |
| PER | Packet Error Rate |
| PHY | Physical Layer |
| PLMN | Public Land Mobile Network |
| PLR | Packet Loss Rate |
| PRACH | Physical Random-Access Channel |
| PRB | Physical Resource Block |
| PRS | Positioning Reference Signal |
| Pscell | Primary cell of a Secondary cell group |
| PSS | Primary Synchronization Signal |
| PT-RS | Phase Tracking-Reference Signal |
| QCL | Quasi Co-Location |
| QoS | Quality of Service (from the physical layer |
| | perspective) |
| RAB | Radio Access Bearer |
| RAN PA | Radio Access Network Paging Area |
| RACH | Random Access Channel (or procedure) |
| RAR | Random Access Response |
| RAT | Radio Access Technology |
| RB | Resource Block |
| RCU | Radio access network Central Unit |
| RF | Radio Front end |
| RE | Resource Element |
| RLF | Radio Link Failure |
| RLM | Radio Link Monitoring |
| RNTI | Radio Network Identifier |
| RO | Random Access Occasion |
| ROM | Read-Only Mode (for MBMS) |
| RRC | Radio Resource Control |
| RRM | Radio Resource Management |
| RS | Reference Signal |
| RTT | Round-Trip Time |
| SCG | Secondary Cell Group |
| SCMA | Single Carrier Multiple Access |
| SCS | Sub-Carrier Spacing |
| SDU | Service Data Unit |
| SOM | Spectrum Operation Mode |
| SP | Semi-persistent |
| SpCell | Primary cell of a master or secondary cell group. |
| SRB | Signaling Radio Bearer |
| SS | Synchronization Signal |
| SSB | SS/PBCH block |
| SRS | Sounding Reference Signal |
| SSS | Secondary Synchronization Signal |
| SUL | Supplementary UpLink |
| SWG | Switching Gap (in a self-contained subframe) |
| TB | Transport Block |
| TBS | Transport Block Size |
| TCI | Transmission Configuration Index |
| TDD | Time-Division Duplexing |
| TDM | Time-Division Multiplexing |
| TI | Time Interval (in integer multiple of one or more symbols) |
| TTI | Transmission Time Interval (in integer multiple of |
| | one or more symbols) |
| TRP | Transmission/Reception Point |
| TRPG | Transmission/Reception Point Group |
| TRS | Tracking Reference Signal |
| TRx | Transceiver |
| UL | Uplink |
| URC | Ultra-Reliable Communications |
| URLLC | Ultra-Reliable and Low Latency Communications |
| V2X | Vehicular communications |
| WLAN | Wireless Local Area Networks and related technologies |
| | (IEEE 802.xx domain) |

5G New Radio (NR) in unlicensed spectrum (NR-U) leverages unlicensed portions of the radio frequency (RF) spectrum to implement cellular networks that would otherwise operate using only licensed bands. Accordingly, NR-U enables a WTRU to establish both uplink and downlink communication links with a gNB in unlicensed bands. Operating in unlicensed bands is unlike operating in licensed bands in that unlicensed bands are shared. Whereas a licensed operator is typically the only user allowed to operate in the licensed band, more than one user or operator can operate in an unlicensed band. Thus, each user operating in an unlicensed band must fairly share the band with other users. To fairly share an unlicensed band in NR-U, a user intending to transmit over either a downlink or an uplink channel first performs a listen-before-talk (LBT) procedure. In this procedure a WTRU or gNB senses the downlink or uplink channel it intends to use to determine whether another user is currently using the channel. If the channel is currently in use, the WTRU or gNB cannot transmit on the channel until the channel is clear.

In a 5G network, a WTRU gains access to resource unit allocations in a cell by an initial procedure to acquire and decode an SSB transmitted by a gNB. As part of the initial procedure the WTRU communicates with the gNB on a frequency indicated to the WTRU as corresponding to an SSB. If the indicated frequency lies within an unlicensed transmission channel, the WTRU is required to perform the Listen before Talk (LBT) procedure before it can transmit on the indicated frequency. If the LBT procedure determines the indicated frequency is currently in use, the WTRU cannot transmit on the indicated frequency. In that case an LBT failure occurs. The LBT failure may result in the WTRU failing to acquire the SSB thereby missing the indicated SSB.

In an example, there is 14 GHz of unlicensed spectrum available at the 60 GHz band that could be used for directional communications. Accordingly, embodiments disclosed herein implementing 5G NR at frequencies above 52.6 GHz is possible, thereby providing high data rate embodiments. However, the implementation of beyond 52.6 GHZ systems poses technical challenges due to the special channel and radiation characteristics at these frequencies. Some implementations disclosed herein provide NR embodiments operating up to 71 GHz considering both licensed and unlicensed operation. Some implementations are structured to provide up to 64 SSB beams for licensed and unlicensed operation in this frequency range. Moreover, some implementations employ 120 kHz subcarrier spacing (SCS) for initially accessing related signals/channels in an initial bandwidth part (BWP).

To accommodate the shared spectrum access procedures such as LBT required to operate in NR unlicensed bands, improved initial access procedures are needed in the corresponding shared spectrum in beyond 52.6 GHZ. For shared spectrum operation, the Listen Before Talk (LBT) procedure is mandatory in many regions. Accordingly, in some embodiments a Clear Channel Assessment (CCA) procedure using energy sensing is performed before every single transmission in the unlicensed bands.

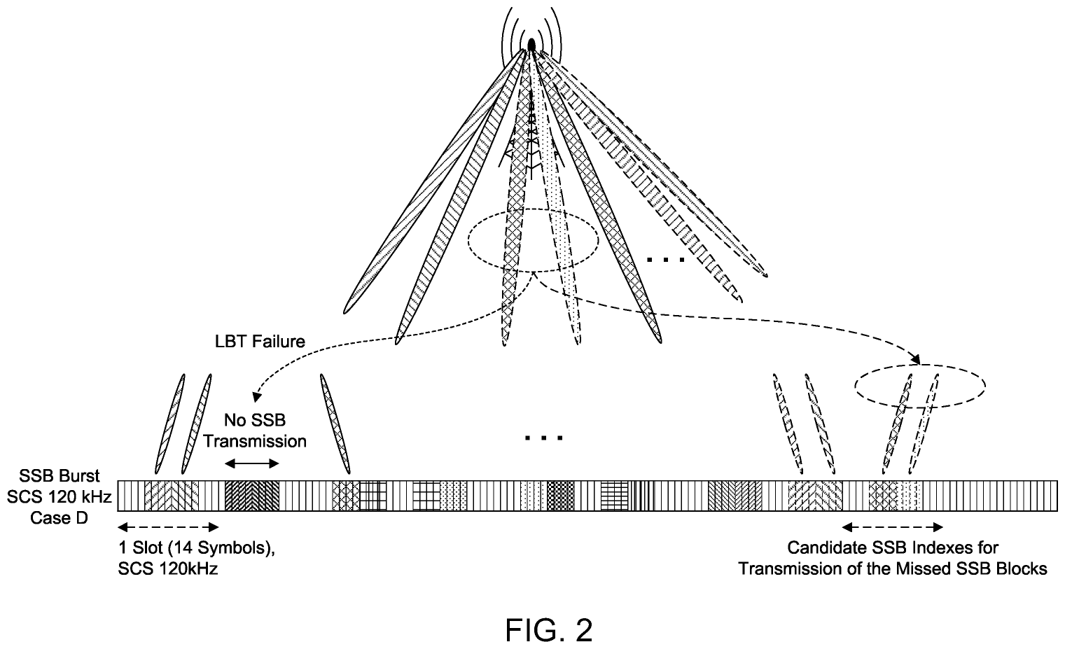

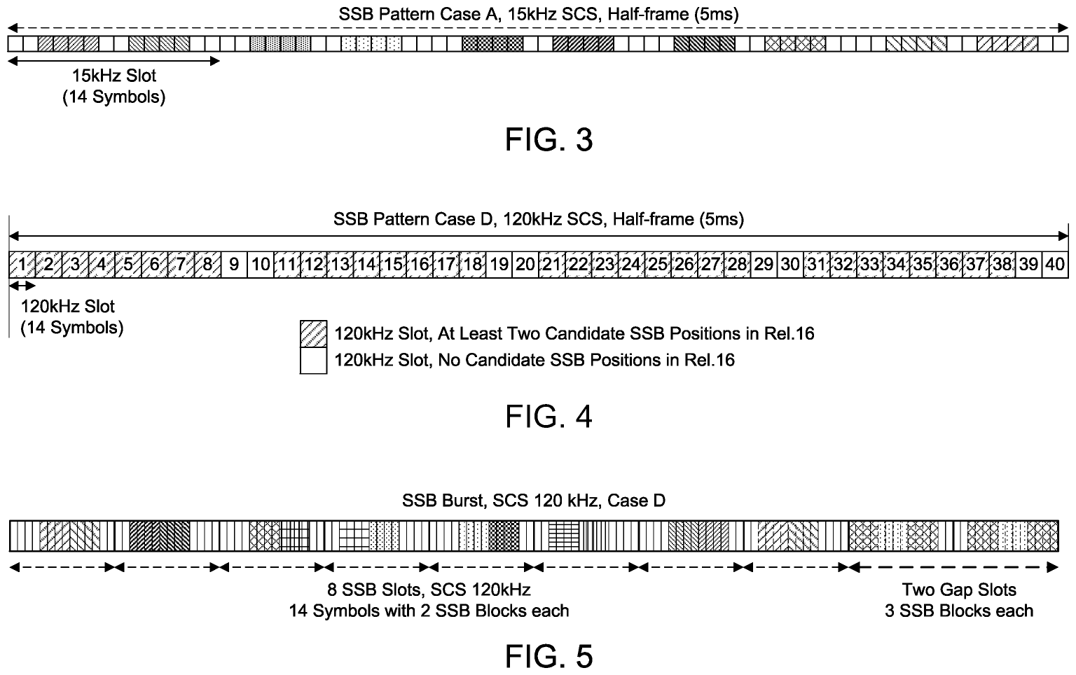

FIG. 2 illustrates an example of transmission of missed SSB blocks (due to the LBT failure) in new candidate SSB positions. An SS/PBCH burst transmission may occur within a half frame, an LBT failure may result in a WTRU or gNB missing the transmission of some of the SS/PBCH blocks. In NR-U, Discovery Burst Transmission Windows (DBTW) are employed to reduce the number of CCA and LBT procedures that must be performed. In an SS/PBCH block transmission, a WTRU can assume that one or more SS/PBCH blocks that fall within the half-frame and are also within the DBTW candidate SS/PBCH block indexes corresponding to an SS/PBCH block index, can be transmitted. This concept is illustrated in FIG. 3.

FIG. 3 shows an SSB pattern Case A with a 15 KHz SCS. In 120 kHz SCS, candidate SS/PBCH block positions are determined based on SS/PBCH block pattern Case D with exactly 64 SS/PBCH block positions within a half frame, as illustrated in FIG. 4. As such, there would be no extra candidate positions left to accommodate the SS/PBCH blocks that were missed due to the LBT failure. However, in an embodiment, the number of SS/PBCH block transmission opportunities may be extended to provide SS/PBCH blocks that are missed due to LBT failures. This presents a challenge as to how to efficiently allocate any additional SSB candidate positions in light of possible LBT failures in SSB block transmission for 120 kHz SCS with 64 SSB beams, WTRU blind detection and SSB candidate determination in THz band when operating in a shared spectrum that requires channel access procedures before taking advantage of transmission opportunity.

To address this challenge, embodiments extend candidate SS/PBCH block indexes into gap slots that occur between SS/PBCH transmissions in NR-U operations that require LBT procedures. Some embodiments extend SSB block positions based on an association between candidate SS/PBCH block positions and SS/PBCH blocks that were missed due to LBT failure. For example, a WTRU receives indicia signifying configurations or patterns of candidate SS/PBCH block indexes associated with a SS/PBCH block index within a DBTW, e.g., within an ssb-PositionsInBurst identified in an SIB1. Based on the block index indicia, the WTRU determines whether a candidate SS/PBCH block index corresponding to the SS/PBCH block index has been received or was missed.

For a missed block index, the WTRU proceeds to detect the missing SSB block in an associated resource by operating in accordance with either one or both of an implicit assumption and an explicit assumption. In the former the WTRU performs blind detection, e.g., based on an RSRP, etc. In the latter, a gNB indicates the allocated resource corresponding to the missing SSB block to the WTRU using, e.g., a reserved sequence or a DCI. In either case, the WTRU assumes that the SSB block it missed will be transmitted at new candidate SSB position.

For cases defined by a 120 kHz SCS, the 8 gap slots within an SSB burst can be used to extend the candidate SS/PBCH Block positions to at least 80 candidate positions, with candidate SSB block indexes up to 128. The gap slots are located right after the bundles of 8 slots with candidate SSB block indexes. In some cases, the new candidate SSB block indexes may only accommodate a subset of missing SSB blocks.

The allocation of the candidate SSB block indexes can be based on one or more of the following approaches. In a first approach (Alt1) candidate SSB Block positions are associated with the missed SSB Blocks. The new candidate SSB block indexes within each gap slot are associated with the missing SSB blocks with an association that is the same as the association that occurred in the preceding bundle of SSB blocks. For example, the new candidate SSB indexes reflect the SSB indexes at the beginning of each bundle of SSB blocks as these are most likely to be missed due to an LBT failure. Accordingly, a range of candidate SSB indexes are considered for each gap slot.

A second approach (Alt. 2) is not based on priority. In this approach missed SSB blocks can be retransmitted in SSB candidate positions based on a “first missed-first served” basis. Some embodiments include a timer for timing transmission of the missed SSBs. If the missed SSBs cannot be transmitted within a given time duration, the WTRU proceeds on an assumption that the missed SSBs have been discarded. In one variation, a predetermined value specifies a threshold number of missed SSBs. If the number of missed SSBs exceeds the threshold number, the WTRU operates on a assumption the SSB transmission was reset.

A third approach (Alt. 3) hybrid association approach is taken. At each of the gap slots, the SSB blocks that were missed during the bundle of 8 SSB slots immediately preceding the corresponding bundle including the candidate gap slots have priority to be retransmitted. Upon transmission of the missed SSB blocks corresponding to the immediately preceding SSB slots, the missed SSB blocks from previous SSB slots are retransmitted based on “first missed-first served” basis.

In some embodiments the WTRU determines the 7th bit by which the candidate SSB index will be represented (from 64-127) based on one of the following: a) the subcarrierSpacingCommon in MIB, b). the LSB of ssb-SubcarrierOffset in the MIB and c) the MSB of controlResourceSetZero in pdcch-ConfigSIB1 in the MIB.

FIG. 5 shows another embodiment in which an SSB pattern that increases the number of SSB candidate indexes. For example, a WTRU receives indicia signifying a first pattern or configuration of the SSB blocks comprising a transmission. The WTRU may be provided with a second, different SSB pattern for the new SSB candidate positions. In the second pattern, instead of two SSB blocks per slot, there may be three consecutive SSB blocks transmitted per gap slot to accommodate 6 candidate SSB block positions. In FIG. 5, the first two symbols within each gap slot are reserved for possible CORESET and UL transmission. Since the SSB blocks in the gap slots are located consecutively, the WTRU may assume the multiplexing patterns 2 or 3 for CORESET #0 and type0-PDCCH that are based on FDM multiplexing.

In other embodiments, the MIB indicates whether to use additional SS/PBCH candidate positions (64 or 80). If the MIB indicates additional SS/PBCH positions, the WTRU receives indications/configurations/patterns of candidate SS/PBCH block indexes associated with a SS/PBCH block index within the discovery burst transmission window, e.g., ssb-PositionsInBurst in SIB1. The WTRU receives an indication of an SSB failure or the blindly detects an SSB failure based on the configurations/patterns. Either way, the WTRU assumes rate matching of the PDSCH/PUSCH around associated candidate SS/PBCH block positions corresponding to the failed SSBs.

In some embodiments, the size of DCI format 1_0 is determined by scrambling it with SI-RNTI. For example, after SS/PBCH block reception, a WTRU monitors and attempts to decode the Type0-PDCCH CSS for SIB1 reception. The WTRU attempts to decode the DCI format 1_0 scrambled with SI-RNTI in Type0-PDCCH CSS, which can produce different numbers of reserved bits. The WTRU may expect a first number of reserved bits, e.g., 17 reserved bits, to signify size of the shared spectrum channel to be accessed, and a second number of reserved bits, e.g., 15 reserved bits, to represent size of the licensed spectrum channel to be accessed.

To avoid blind decoding ambiguity, the WTRU may assume a size of the DCI format 1_0 is the same, whether operating in a shared (unlicensed) or unshared (licensed) portion of the spectrum, as well as in CSS and USS. This can be independent of which RNTI code is scrambled with the CRC. To achieve the size alignment in the DCI formats, the size of DCI format 0_0 is made to correspond to the size of the DCI format 1_0, whether or not operating in a shared spectrum, as well as in CSS and USS and independent of which RNTI code is scrambled with the CRC.

Moreover, the WTRU may determine the size of the DCI format 1_0 based on different first and second RNTI. For example, the first RNTI may be a first SI-RNTI (e.g., SI-RNTI-1) associated with the size of DCI format 1_0 for operation without a shared spectrum. And the second RNTI may be a second SI-RNTI (e.g., SI-RNTI-2) associated with the size of DCI format 1_0 for operation with shared spectrum operation.

Furthermore, the WTRU may determine the mode of operation based on the different first and second RNTI. For example, the mode of operation may be the license regime, LBT on/off, DBTW enabled/disabled. For example, the first RNTI may be a first SI-RNTI (e.g., SI-RNTI-1) associated with operation in a licensed (not shared) portion of the spectrum and the second RNTI may be a second SI-RNTI (e.g., SI-RNTI-2) associated with operation in a shared (unlicensed) portion of the spectrum.

Further, embodiments provide an improved SS/PBCH pattern that accommodates a greater number of SS/PBCH block candidate indexes. Some embodiments provide an indication of extra candidate SS/PBCH block indexes as well as providing rate-matching around the SS/PBCH blocks. Some embodiments provide up to 64 possible candidate SS/PBCH block indexes (or positions) for block transmissions. Embodiments are contemplated that extend the number of indexes from 64 to 80. Some embodiments provide an SS/PBCH block index that identifies the operations/resources required for initial access as well as identifying other resources.

According to some embodiments, a WTRU transmits or receives a physical channel or reference signal according to at least one spatial domain filter. The term “beam” is used herein may refer to a spatial domain filter. A spatial domain filter may utilize some combination of the beamforming and precoding based on directional antennas in spatial domain. A WTRU may select a physical channel or signal for transmission using the same spatial domain filter (beam) as the spatial domain filter (beam) upon which the WTRU received an RS (such as CSI-RS) or an SS block. The physical channel selected by the WTRU for transmission is referred to herein as a “target” physical channel, and the physical channel upon which the WTRU received RS or SS block is referred to herein as a “reference” or “source” physical channel. Thus, the WTRU may select the target physical channel or signal (beam) to be used for transmission according to a spatial relationship with a corresponding reference physical channel (beam) over which the WTRU received RS or SS block. Furthermore, in some implementations, the WTRU selects a first physical channel or signal for transmission according to the same spatial domain filter (beam) as the spatial domain filter (beam) selected or for transmitting a second physical channel or signal. In those implementations, the first and second physical channels are referred to as “target” and “reference” (or “source”) channels, respectively. Thus, the WTRU is said to transmit the first (target) physical channel or signal according to a spatial relationship with respect to the second (reference) physical channel or signal.

A spatial relationship may be implicit or it may be configured by an RRC or it may be signaled by a MAC CE or DCI. For example, a WTRU may implicitly transmit PUSCH and DM-RS of PUSCH according to the same spatial domain filter (beam) as an SRS corresponding to an SRI as indicated in DCI or as configured by RRC. In another example embodiment, a spatial relationship is configured by RRC for an SRS resource indicator (SRI). Alternatively, the spatial relationship is signaled by MAC CE for a PUCCH. Such a spatial relationship is also referred to herein as a “beam indication”.

In some implementations a WTRU receives a first (target) downlink channel or signal according to the same spatial domain filter or spatial reception parameter as a second (reference) downlink channel or signal. For example, an association may exist between a physical channel such as PDCCH or PDSCH, and its respective DM-RS. At least when the first and second signals are reference signals, such association exists when the WTRU is configured based upon an assumption a quasi-colocation (QCL) of type D exists between corresponding antenna ports. Such association may be indicated as a particular TCI (transmission configuration indicator) state. A WTRU may be provided with indication of an association between a CSI-RS or SS block and a DM-RS, e.g., by an index to a set of TCI states configured by RRC and/or signaled by MAC CE. Such an indication is also referred to herein as a “beam indication”.

As used herein the term shared spectrum, i.e., shared medium, i.e., shared frequency bands is understood as referring to unlicensed portion of the RF spectrum and encompasses in some embodiments both license exempt portions of the RF spectrum as well as lightly licensed portions of the RF spectrum.

In some embodiments described herein, a WTRU operates within shared portions of the spectrum based on an assumption it will receive SS/PBCH blocks in a half frame within Discovery Burst Transmission Windows (DBTW). In some implementations, the WTRU determines properties of the DBTW based on one or more of the following: DBTW Duration and DBTW Periodicity. According to the former, the WTRU determines the duration of the DBTW based on a DiscoveryBurst-WindowLength value, where provided. Otherwise, the WTRU considers the duration of the DBTW to be the half-frame. According to the latter, the WTRU assumes the DBTW has the same period as the half-frame corresponding to the reception of the SS/PBCH blocks in a serving cell.

In some embodiments a WTRU determines quasi co-location (QCL) relationships between SS/PBCH blocks within a same DBTW, or across DBTWs based on the corresponding SS/PBCH block index when the WTRU is transmitting in unlicensed bands. Likewise, when the WTRU is transmitting in unlicensed bands, the WTRU operates on an assumption the SS/PBCH blocks within a same DBTW or across DBTWs are quasi co-located (QCL-ed) with respect to average gain, quasi co-location ‘typeA’ and ‘typeD’ properties, if the value of (ι̅mod N_{SSB}^{QCL}) is the same among the SS/PBCH blocks. The parameter z is the candidate SS/PBCH block index and N_{SSB}^{QCL} is the Q parameter that indicates the QCL relation between SS/PBCH blocks.

In some embodiments, upon receiving an SS/PBCH block, the WTRU determines a value of the candidate SS/PBCH block using the PBCH in the SS/PBCH block. For example, the WTRU may determine the 3 LSB bits of a candidate SS/PBCH block index per half frame from a one-to-one mapping with an index of the DM-RS sequence transmitted in the PBCH. For maximum SS/PBCH beams equal to 64, the WTRU determines the 3 MSB bits of the candidate SS/PBCH block index from PBCH payload bits ā_{Ā+5}, ā_{Ā+6}, ā_{Ā+7}.

The WTRU determines Q parameter, N_SSB\hat{ }QCL, based on ssb-PositionQCL in System Information Block (SIB) or based on parameters in Master Information Block (MIB). The WTRU may assume that the number of SS/PBCH blocks transmitted within a DBTW is not larger than N_SSB\hat{ }QCL. Also, the number of SS/PBCH blocks transmitted within a DBTW with a same SS/PBCH block index is not more than one.

In some embodiments an SS/PBCH Block pattern correspond to an SCS of 120 KHz (Case D). A WTRU may determine the SS/PBCH block pattern according to the SCS of the SS/PBCH block. The WTRU may determine the SS/PBCH block pattern based on the first symbol indexes for candidate SS/PBCH blocks, where index 0 corresponds to the first symbol of the first slot within a half-frame. For these SS/PBCH blocks (those with 120 KHz SCS) CASE D defines the SS/PBCH block pattern, according to which the first symbol of the candidate SS/PBCH blocks have indexes {4, 8, 16, 20}+28n, wherein n=0, 1, 2, 3, 5, 6, 7, 8, 10, 11, 12, 13, 15, 16, 17, 18.

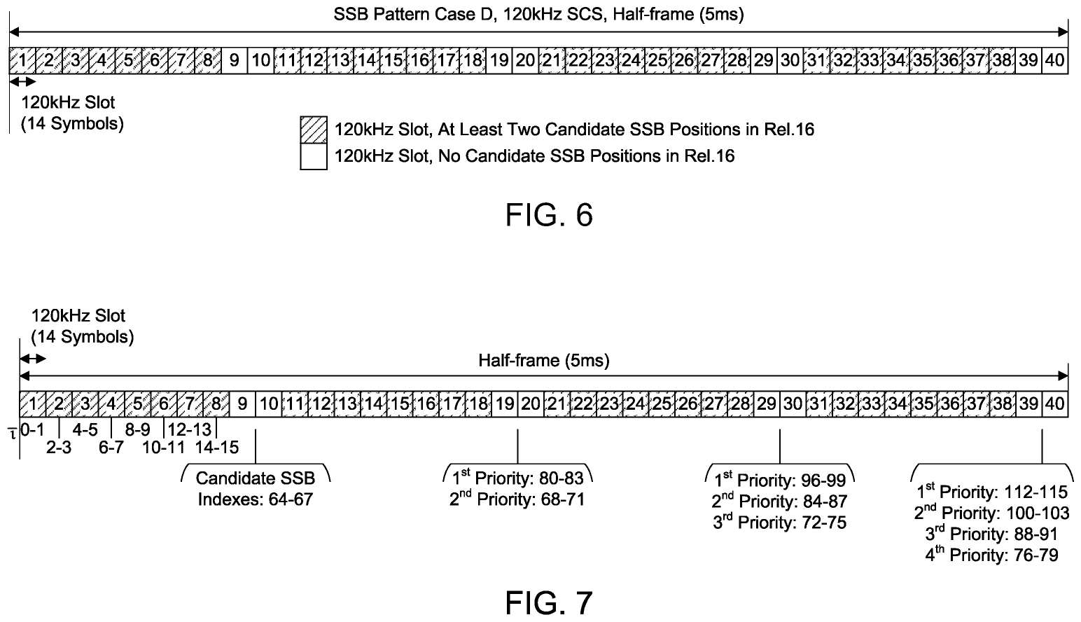

FIG. 6 illustrates a typical SS/PBCH block pattern within a half-frame, wherein each of the SS/PBCH slots is shown to include two SS/PBCH blocks. In the Case D SS/PBCH block pattern, there are two gap slots after each bundle of eight SS/PBCH slots to which no candidate SS/PBCH corresponds. These two gap slots are provided mainly for CORESET or uplink transmissions.

In a solution, a WTRU may determine new candidate SS/PBCH block positions within the gap slots, for 120 kHz SCS with maximum SS/PBCH beam of 64, wherein WTRU may expect to receive the SS/PBCH blocks that are missing, e.g., due to the LBT failure. The WTRU may assume that each gap slot has two candidate SS/PBCH block positions, where the first symbol of the candidate SS/PBCH blocks have indexes {4, 8, 16, 20}+28n, wherein n=4, 9, 14, 19, and that the index 0 for the candidate SS/PBCH blocks indexes corresponds to the first symbol of the first slot within a half-frame. The WTRU may determine or be configured such that the number of candidate SS/PBCH block positions are at least 80. As such, the candidate SS/PBCH block indexes may range within i ={0, 1, . . . , 127}, corresponding to SS/PBCH block index (i mod 64).

In some embodiments, the WTRU may monitor the synchronization raster to receive, detect, decode, or identify one or more SS/PBCH block within a half-frame. A synchronization raster may indicate the frequency positions of a synchronization block (e.g., SS/PBCH block) that can be used by a WTRU for system acquisition when explicit signaling indicating the frequency positions of the synchronization block is not present. The WTRU may perform one or more of the following possible activities using a synchronization raster.

According to a first possible activity, the WTRU recovers information from the SS/PBCH block including PSS, SSS, and PBCH.

According to a second possible activity, the WTRU determines the candidate SS/PBCH block index from PBCH. For example, the WTRU determines the 3 LSB bits of the candidate SS/PBCH block index per half frame from a one-to-one mapping with an index of the DM-RS sequence transmitted in the PBCH. For maximum SS/PBCH beams equal to 64, the WTRU determines the 3 MSB bits of the candidate SS/PBCH block index from PBCH payload bits a _(A+ 5), a _(A +6), a _(A+7). For maximum SS/PBCH beams equal to 64, and the candidate SS/PBCH block positions at least equal to 80, and the candidate SS/PBCH block indexes ranging from 0 to 127, the WTRU determines the 4th MSB bit of the candidate SS/PBCH block index based on MIB. For example, one of the following may be applied: a) the subcarrierSpacingCommon in MIB, b) the LSB of ssb-SubcarrierOffset in MIB, and c) the MSB of controlResourceSetZero in pdcch-ConfigSIB1 in MIB.

Another embodiment associates the candidate SS/PBCH block positions with the missing SS/PBCH blocks according to a priority. For example, the WTRU may expect that the LBT failure will occur with higher probability for the SS/PBCH block indexes at the beginning of each bundle of eight SS/PBCH block slots. The WTRU operates on an assumption that upon successful LBT, the channel remains occupied for the successive SS/PBCH blocks transmitted within each bundle of eight SS/PBCH block slots. However, the gap slots between SS/PBCH block slots are longer than the gaps allowed within a Maximum Channel Occupancy Time (MCOT), e.g., longer than 16 usec gaps. Therefore, the LBT procedure may be required again before the next bundle of eight SS/PBCH block slots is transmitted. In that case the WTRU assumes that the LBT failure will occur with higher probability for the SS/PBCH block indexes at the beginning of each bundle of eight SS/PBCH block slots.

For example, the WTRU assumes that the probability of missing SS/PBCH block indexes 0-3 in the first bundle is higher than the rest of the SS/PBCH block indexes within the first bundle, i.e. SS/PBCH block indexes 4-15. Further, the WTRU assumes that the probability of missing SS/PBCH block indexes 16-19 in the second bundle is higher than the rest of the SS/PBCH block indexes within the second bundle, i.e. SS/PBCH block indexes 20-31. Further, the WTRU assumes that the probability of missing SS/PBCH block indexes 32-35 in the third bundle is higher than the rest of the SS/PBCH block indexes within the third bundle, i.e. SS/PBCH block indexes 36-47. Likewise, the WTRU assumes that the probability of missing SS/PBCH block indexes 48-51 in the fourth bundle is higher than the rest of the SS/PBCH block indexes within the fourth bundle, i.e. SS/PBCH block indexes 52-63.

Alternatively, the WTRU assumes that in case the gap slots are used for the transmission of the missing SS/PBCH blocks, the channel occupancy will be extended resulting in no gaps between the bundles of eight SS/PBCH block slots and therefore no need for performing LBT before the next bundles of eight SS/PBCH block slots.

In some implementations, the WTRU expects fixed candidate SS/PBCH block positions within the gap slots, whereby the WTRU can determine the slot number, the symbol number, and whether an SS/PBCH block is retransmitted (e.g., due to the LBT failure), based on the decoded candidate SS/PBCH block index.

FIG. 7 an SSB pattern using 8 available gap slots within the SSB burst as the new candidate SSB positions based on prioritized association according to embodiments. The solution of FIG. 7 is an example of a mode 1, or a prioritization solution. In FIG. 7 SSBs that may be missing due to LBT failure are placed in available slots between SSB bundles. It should be noted that an actual SSB index may be a candidate SSB index mod 64; and candidate SSBs 64-127 may correspond to actual SSBs 0-63.

In the mode 1 solution, LBT failure may occur with a higher probability for the SSB indexes at the beginning of each bundle of eight SSB slots. Therefore, transmission of the SSBs at the beginning of each bundle is prioritized: 64-67, then 0-3, then 80-83, then 16-19, and so on. In other words, this case is optimized for the case when the gNB wants to send all the SSBs in the bundles but can not due to at least some LBT conflicts.

In an example, the WTRU operates based on one or more of the following assumptions or determinations. For i <64, the WTRU assumes or determine that the original SS/PBCH block was transmitted, thus the slot number and the index number can be determined accordingly. For 64≤i <68, the WTRU assumes or determines that the received SS/PBCH block is the transmission or retransmission of the SS/PBCH block corresponding to SS/PBCH block index (i mod 64). The WTRU determines the slot number within the half frame based on the recovered SS/PBCH block, to be equal to 9 for i =64 or 65, and 10 for i =66 or 67. The WTRU assumes or determines the symbol number based on the fixed location of the SS/PBCH block indexes within the gap slots 9 and 10.

For 80≤i <84, the WTRU assumes or determines that the received SS/PBCH block is the transmission or retransmission of the SS/PBCH block corresponding to SS/PBCH block index (i mod 64). The WTRU determines the slot number within the half frame based on the recovered SS/PBCH block, to be equal to 19 for i =80 or 81, and 20 for i =82 or 83. The WTRU assumes or determines the symbol number based on the fixed location of the SS/PBCH block indexes within the gap slots 19 and 20.

For 96≤i <100, the WTRU may assume or determine that the received SS/PBCH block is the transmission or retransmission of the SS/PBCH block corresponding to SS/PBCH block index (i mod 64). The WTRU determines the slot number within the half frame based on the recovered SS/PBCH block, to be equal to 29 for i =96 or 97, and 30 for i =98 or 99. The WTRU assumes or determines the symbol number based on the fixed location of the SS/PBCH block indexes within the gap slots 29 and 30.

For 112≤i <116, the WTRU may assume or determine that the received SS/PBCH block is the retransmission of the SS/PBCH block corresponding to SS/PBCH block index (i mod 64). The WTRU determines the slot number within the half frame based on the recovered SS/PBCH block, to be equal to 39 for i =112 or 113, and 40 for i =114 or 115. The WTRU assumes or determines the symbol number based on the fixed location of the SS/PBCH block indexes within the gap slots 39 and 40.

In the above determinations or assumptions, i is the SS/PBCH block index (or the candidate SS/PBCH block index) determined by the WTRU, for example for a received SS/PBCH block. The WTRU determines the slot of the received SS/PBCH block as a gap slot. The WTRU determines the symbol of the received SS/PBCH block as a symbol in a gap slot. The symbol and/or slot may be determined based on the determined candidate SS/PBCH block index or the determined SS/PBCH block index.

Alternatively, the WTRU may expect to receive candidate SS/PBCH indexes within the gap slots other than abovementioned scenarios. In this case, WTRU may assume or determine that SS/PBCH blocks corresponding to the abovementioned candidate SS/PBCH block indexes were not missed (e.g., due to the LBT failure).

The WTRU may expect to receive other missed SS/PBCH blocks in the gap slots. For example, for 68≤i <72, the WTRU may assume or determine that the received SS/PBCH block is the transmission or retransmission of the SS/PBCH block corresponding to SS/PBCH block index (i mod 64). The WTRU may assume or determine that the SS/PBCH block indexes 64-67 were also missed (e.g., due to the LBT failure) and that they were already transmitted or retransmitted in slots 9 and 10 within the SS/PBCH block burst in the corresponding half-frame. The WTRU may determine the slot number within the half frame based on the recovered SS/PBCH block, to be equal to 19 for i =68 or 69, and 20 for i =70 or 71. The WTRU may assume or determine the symbol number based on the fixed location of the SS/PBCH block indexes within the gap slots 19 and 20.

For 72≤i <76, the WTRU may assume or determine that the received SS/PBCH block is the transmission or retransmission of the SS/PBCH block corresponding to SS/PBCH block index (i mod 64). The WTRU may assume or determine that the SS/PBCH block indexes 64-71 were also missed (e.g., due to the LBT failure) and that they were already transmitted or retransmitted in slots 9, 10, 19, and 20 within the SS/PBCH block burst in the corresponding half-frame. The WTRU may determine the slot number within the half frame based on the recovered SS/PBCH block, to be equal to 29 for i =72 or 73, and 30 for i =74 or 75. The WTRU may assume or determine the symbol number based on the fixed location of the SS/PBCH block indexes within the gap slots 29 and 30.

For 76≤i <80, the WTRU may assume or determine that the received SS/PBCH block is the transmission or retransmission of the SS/PBCH block corresponding to SS/PBCH block index (i mod 64). The WTRU may assume or determine that the SS/PBCH block indexes 64-75 were also missed (e.g., due to the LBT failure) and that they were already transmitted or retransmitted in slots 9, 10, 19, 20, 29, and 30 within the SS/PBCH block burst in the corresponding half-frame. The WTRU may determine the slot number within the half frame based on the recovered SS/PBCH block, to be equal to 39 for i =76 or 77, and 40 for i =78 or 79. The WTRU may assume or determine the symbol number based on the fixed location of the SS/PBCH block indexes within the gap slots 39 and 40.

For 84≤i <88, the WTRU may assume or determine that the received SS/PBCH block is the transmission or retransmission of the SS/PBCH block corresponding to SS/PBCH block index (i mod 64). The WTRU may assume or determine that the SS/PBCH block indexes 80-83 were also missed (e.g., due to the LBT failure) and that they were already transmitted or retransmitted in slots 19 and 20 within the SS/PBCH block burst in the corresponding half-frame. The WTRU may determine the slot number within the half frame based on the recovered SS/PBCH block, to be equal to 29 for i =84 or 85, and 30 for i =86 or 87. The WTRU may assume or determine the symbol number based on the fixed location of the SS/PBCH block indexes within the gap slots 29 and 30.

For 88≤i <92, the WTRU may assume or determine that the received SS/PBCH block is the transmission or retransmission of the SS/PBCH block corresponding to SS/PBCH block index (i mod 64). The WTRU may assume or determine that the SS/PBCH block indexes 80-87 were also missed (e.g., due to the LBT failure) and that they were already transmitted or retransmitted in slots 19, 20, 29, and 30 within the SS/PBCH block burst in the corresponding half-frame. The WTRU may determine the slot number within the half frame based on the recovered SS/PBCH block, to be equal to 39 for i =88 or 89, and 40 for i =90 or 91. The WTRU may assume or determine the symbol number based on the fixed location of the SS/PBCH block indexes within the gap slots 39 and 40.

For 100≤i <104, the WTRU may assume or determine that the received SS/PBCH block is the transmission or retransmission of the SS/PBCH block corresponding to SS/PBCH block index (i mod 64). The WTRU may assume or determine that the SS/PBCH block indexes 96-99 were also missed (e.g., due to the LBT failure) and that they were already transmitted or retransmitted in slots 29, and 30 within the SS/PBCH block burst in the corresponding half-frame. The WTRU may determine the slot number within the half frame based on the recovered SS/PBCH block, to be equal to 39 for i =100 or 101, and 40 for i =102 or 103. The WTRU may assume or determine the symbol number based on the fixed location of the SS/PBCH block indexes within the gap slots 39 and 40.

In another embodiment candidate SS/PBCH block positions are associated with the missing SS/PBCH blocks using a hybrid approach that combines a priority based approach to association, of the SS/PBCH blocks with an association on a “first missed-first served” basis.

In another solution, the WTRU expects the same probability of LBT failure for each and every one of the SS/PBCH blocks. In an example, directional LBT before SS/PBCH block transmission may result in missing any of the SS/PBCH blocks throughout the SS/PBCH block burst. The WTRU may assume that the missing of the SS/PBCH blocks due to the LBT failure may occur within the subsets of SS/PBCH beams, for example subsets of 4 SS/PBCH beams. In an example, the directional LBT failure may affect the closer SS/PBCH beams with more probability than the farther SS/PBCH beams. Alternatively, the WTRU may assume the reception of the missed SS/PBCH blocks will occur on a “first missed-first served” basis. As such, the WTRU may expect that the positioning of the candidate SS/PBCH blocks within each gap slot is according to a hybrid of “first missed-first served” and priority-based assignment of subsets of the candidate SS/PBCH block indexes corresponding to the bundle of the eight SS/PBCH block slots right before the corresponding gap slot.

The WTRU may expect fixed candidate SS/PBCH block positions within the gap slots, where the WTRU may determine the slot number, the symbol number, and if an SS/PBCH block is transmitted or retransmitted, e.g., due to the LBT failure, based on the decoded candidate SS/PBCH block index.

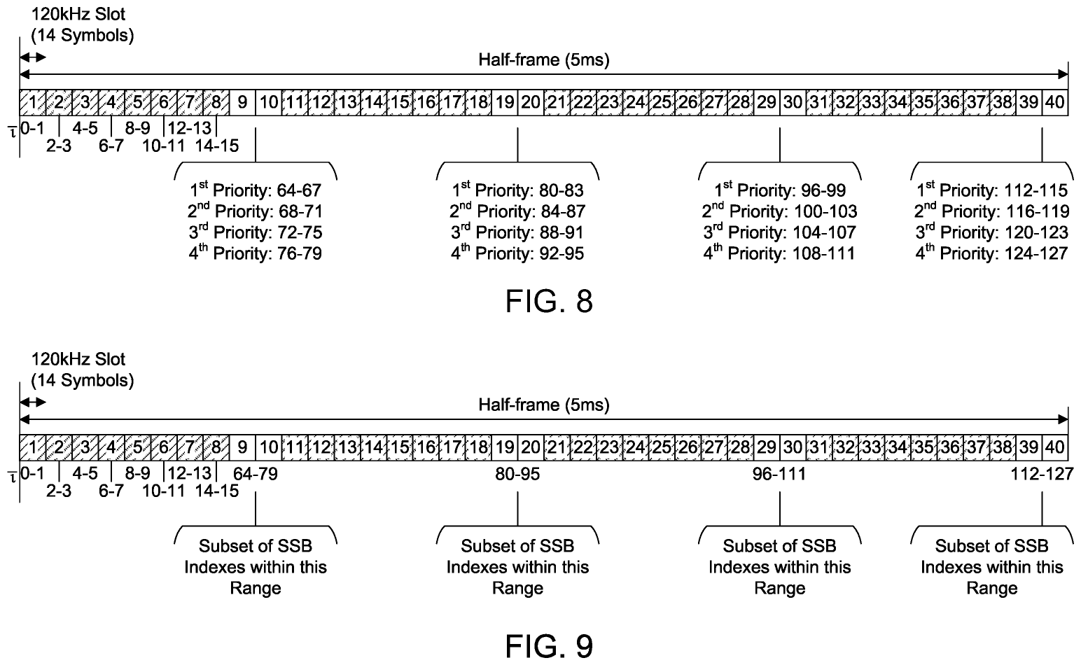

FIG. 8 illustrates an example SSB pattern using the 8 available gap slots within the SSB burst as the new candidate SSB positions based on hybrid positioning of the candidate SS/PBCH block positions according to embodiments. The example of FIG. 8 is a mode 2, or a hybrid model based on priority and a “first missed-first served” solution. This approach is optimized for the case when the gNB does not need to send all the SSBs in each bundle, and can't send some of them due to LBT conflicts.

In an example, For i <64, the WTRU may assume that the original SS/PBCH block was transmitted and so the slot number and the index number can be determined accordingly. For 64≤i <68, 68≤i <72, 72≤i <76, and 76≤i <80, the WTRU may assume that the received SS/PBCH block is the transmission or retransmission of the SS/PBCH block corresponding to SS/PBCH block index (i mod 64). The WTRU may determine the slot number within the half frame based on the recovered SS/PBCH block, to be equal to slot 9 for i =64, 65, 68, 69, 72, 73, 76, 77, and slot 10 for i =66, 67, 70, 71, 74, 75, 78, 79. The WTRU may determine the symbol number based on the fixed location of the SS/PBCH block indexes within the gap slots 9 and 10.

For 80≤i <84, 84≤i <88, 88≤i <92, and 92≤i <96, the WTRU may determine that the received SS/PBCH block is the transmission or retransmission of the SS/PBCH block corresponding to SS/PBCH block index (i mod 64). The WTRU may determine the slot number within the half frame based on the recovered SS/PBCH block, to be equal to slot 19 for i ==80, 81, 84, 85, 88, 89, 92, 93 and slot 20 for i =82, 83, 86, 87, 90, 91, 94, 95. The WTRU may determine the symbol number based on the fixed location of the SS/PBCH block indexes within the gap slots 19 and 20.

For 96≤i <100, 100≤i <104, 104≤i <108, and 108≤i <112, the WTRU may determine that the received SS/PBCH block is the retransmission of the SS/PBCH block corresponding to SS/PBCH block index (i mod 64). The WTRU may determine the slot number within the half frame based on the recovered SS/PBCH block, to be equal to slot 29 for i =96, 97, 100, 101, 104, 105, 108, 109 and slot 30 for i =98, 99, 102, 103, 106, 107, 110, 111. The WTRU may determine the symbol number based on the fixed location of the SS/PBCH block indexes within the gap slots 29 and 30.

For 112≤i <116, 116≤i <120, 120≤i <124, and 124≤i <128, the WTRU may determine that the received SS/PBCH block is the retransmission of the SS/PBCH block corresponding to SS/PBCH block index (i mod 64). The WTRU may determine the slot number within the half frame based on the recovered SS/PBCH block, to be equal to slot 39 for i =112, 113, 116, 117, 120, 121, 124, 125 and slot 40 for i =114, 115, 118, 119, 122, 123, 126, 127. The WTRU may determine the symbol number based on the fixed location of the SS/PBCH block indexes within the gap slots 39 and 40.

In some non-initial access cases, slot number and symbol number for an SS/PBCH block are known to the WTRU. For example, a WTRU may identify, determine, or be configured the synchronization information, slot number, or the symbol number from higher layer information, e.g., RRC, DCI, etc. In SS/PBCH blocks for non-initial access cases, the WTRU doesn't use the SS/PBCH blocks for synchronization purposes or for determining the slot number or the symbol number within the half-frame.

The WTRU may assume that a range of the candidate SS/PBCH blocks can be located at each gap slots, where a subset of the candidate SS/PBCH block indexes may be transmitted at a time, see FIG. 9. For example, WTRU may assume to receive a subset of 4 candidate SS/PBCH block indexes out of the range of 64≤i <80 in gap slot pairs (9,10). Likewise, the WTRU may assume to receive a subset of 4 candidate SS/PBCH block indexes out of the range of 80≤i <96, 96≤i <112, or 112≤i <128 in gap slot pairs (19,20), (29,30), or (39,40), respectively.

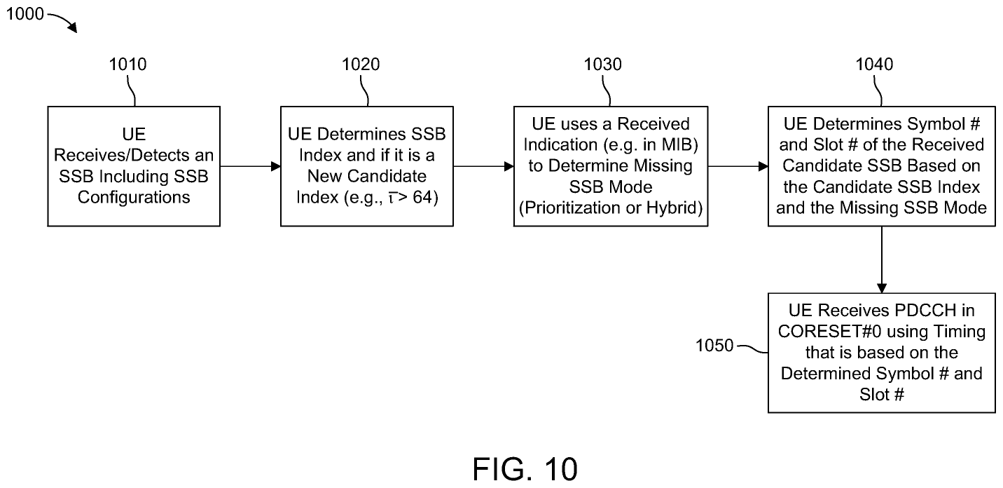

FIG. 10 shows an example process 1000 for a WTRU to determine symbol and slot number of the received candidate SSB based on the SSB index and the missing SSB mode. The WTRU receives or detects an SSB including SSB configurations at 1010. Then the WTRU determines an SSB index and whether it is a new candidate index, at 1020. Next, the WTRU uses a received indication to determine which missing SSB mode to operate, at 1030. For example, the WTRU may receive the indication in a MIB. It should be noted that in addition to the MIB during initial access, the mode may be configured via SIB, RRC, MAC-CE, DCI or any other control signaling. The missing SSB mode may be one of a first mode or a second mode. For example, the first mode may be a prioritization mode, where SSBs at the beginning of each SSB candidate bundle are prioritized, and the second mode may be a hybrid model based on priority and first missed-first served. Other possible missed SSB modes and order of priorities are possible and within the scope of the invention. For example, for directional LBT, one or more directions (e.g., indicated via TCI state, or QCL relation) may be prioritized. Next, the WTRU determines a symbol number and slot number for the received candidate SSB, at 1040. This determination may be based on the candidate SSB index and/or the indicated missing SSB mode. The WTRU may then receive a PDCCH transmission in CORESET #0 using timing that is based on the determined symbol number and slot number, at 1050. It should be noted that while described separately with respect to FIG. 10, it is possible that the steps 1010-1030 may be combined in some fashion so that the WTRU receives a candidate SSB in set of symbols in a slot and an indication of a mode of association between candidate SSB positions and candidate SSB indexes.

A WTRU may receive a physical broadcast channel (PBCH). The PBCH may carry system information. The PBCH may include or carry a master information block (MIB). The term MIB may be used to represent the content, information, payload, and/or bits carried by the PBCH. PBCH and MIB may be used interchangeably herein. The PBCH may be part of an SS/PBCH block (SSB). The SSB may have an SSB index. A gNB or cell may transmit one or more SSBs where each SSB may have an SSB index. In an example, a gNB or cell may transmit up to 64 SSBs and 6 bits may be used for the SSB index. In some cases, there may be candidate SSBs where each candidate SSB may have a candidate SSB index. A WTRU may determine an SSB index from a candidate SSB index.

The content of a PBCH may include a first set of payload bits and a second set of payload bits. The first set of payload bits may be timing related payload. The first set of payload bits may be received in the M MSBs of the PBCH transport block. The second set of bits may be received in the L LSBs of the PBCH payload. The L LSBs may be adjacent to the M MSBs. The first set of payload bits may be inserted and/or extracted by the PHY layer. The second set of bits may be provided and or used by the higher layers.

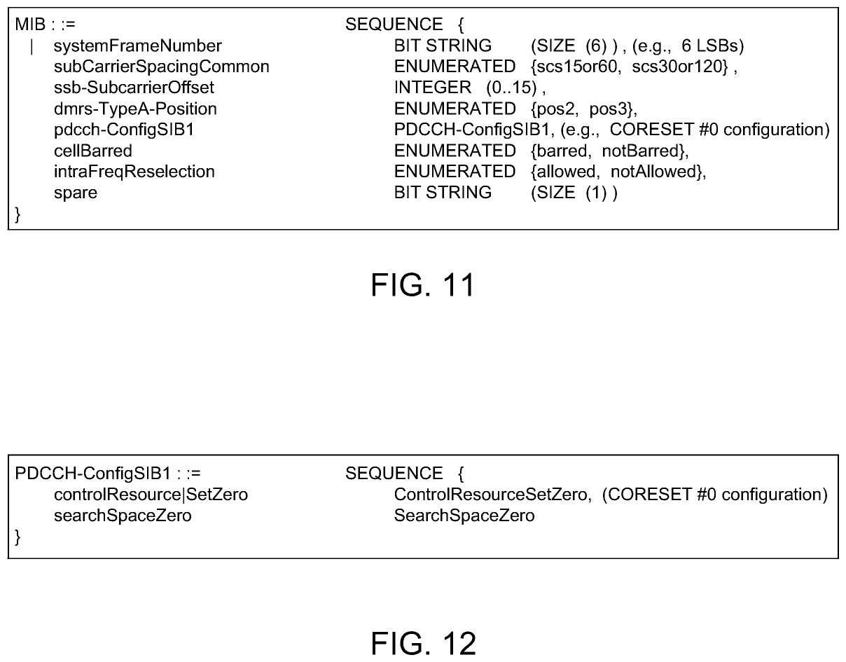

FIG. 11 shows an MIB including example operating parameters that may be included in the second set of PBCH/MIB payload bits according to embodiments.

FIG. 12 shows example contents of PDCCH-ConfigSIB1 according to embodiments.

In an example, the first set of PBCH payload bits may include one or more of the following: a) one or more bits of a system frame number (SFN) such as a number of LSBs (e.g., 4 LSBs) of a system frame number (SFN); b) a half radio frame bit; c) a number of bits (e.g., MSBs) of the SSB index or candidate SSB index of the SSB of the PBCH, for example a number of MSBs of the SSB index or candidate SSB index.

The number of bits of the SSB index or candidate SSB index may, for example be 2 or 3 bits. In an example the number of SSB indexes or candidate SSB indexes may be 64 and the SSB (or candidate SSB) index may be represented by 6 bits. The LSBs (e.g., 3 LSBs) of SSB or candidate SSB index may be determined by the WTRU from a DMRS received with the PBCH of the SSB. The MSBs (e.g., 3 LSBs) may be determined from PBCH, e.g., from the first set of payload bits of the PBCH. The second set of PBCH payload bits may include one or more operating parameters. An example of system operating parameters that may be included in the second set of payload bits is shown in FIG. 12. The figure is a non-limiting example of the parameters that may be included in the second set of payload bits. One or more of those parameters may be included. The number of bits and choices for each parameter are examples. Other numbers of bits or choices may be included.

When operating in high frequencies in an unlicensed band, a technical problem arises in that more candidate SSB indexes may be added to correspond to SSBs a gNB could not transmit some because a corresponding channel was busy. As a result, more bits may be needed to represent added SSB (or candidate SSB) indexes. To address this challenge, one embodiment adds SSB MSBs in the MIB PHY part. For example, N bits may be added to represent additional SSB (or candidate SSB) indexes when operating in a first frequency band or range. The N bits are in addition to the M bits used to represent the SSB (or candidate SSB) index when operating in a second frequency band or range that is lower that the first frequency band or range, or that may be a first type of band or range, e.g., a licensed band or range as opposed to a second type of band or range, e.g., an unlicensed band or range.

N is 1 or more. Thus, the total number of bits by which the SSB (or candidate SSB) index is represented is M+N. In some implementations, the N bits correspond to N MSBs of the SSB (or candidate SSB) index. The N bits may be included in the first set of PBCH payload bits or the second set of PBCH payload bits. For example, there may be 3 bits in the first set of PBCH payload bits corresponding to the 3 MSBs of a 6-bit SSB/candidate SSB index. The bits may be ordered as the 6th, 5th and 4th bits of the SSB/candidate SSB index, respectively, in descending order from the MSB. When a 7th bit is to be added, the 7th bit may be placed before the 6th bit or after the 4th bit of the SSB/candidate SSB index in the first set of PBCH payload bits. If N additional bits are added, they may be added before the 6th bit or after the 4th bit. If placed before the 6th bit, the MSBs of the index will be in order from MSB to next MSB, etc. If the N additional bits are placed after the 4th bit, bits 6, 5, 4 will be ordered first, followed by the N MSBs of the index.

In a more general example, for an SSB/candidate SSB index of N+M bits, where the N bits are the MSBs, the first set of PBCH payload bits may contain the L MSBs of the M bits and the N MSBs. The N MSBs may be placed before or after the L MSBs of the M bits. It may be desired that the total number of PBCH payload bits does not change. Use of N additional bits in the first set of PBCH payload bits may result in use of fewer bits in the second set of PBCH payload bits. In another example, the N bits may be included in the second set of PBCH payload bits or some of the N bits may be included in the first set of PBCH payload bits and some other of the N bits may be included in the second set of PBCH payload bits.

In some embodiments the WTRU receives the first and/or second set of the PBCH payload bits. The payload bits contain the bits representing or corresponding to the SSB or candidate SSB index as described herein. The WTRU determines the SSB or candidate SSB index from the first and/or second set of PBCH payload bits. The WTRU determines the N+L MSBs of the SSB or candidate SSB index. The WTRU receives the PBCH DMRS and determines the M-L LSBs of the SSB or candidate SSB index from the PBCH DMRS sequence.

In some implementations, the PBCH payload order/contents depend on the frequency band or range. A WTRU may operate in one or more frequency bands or ranges. A frequency band or range may, for example be at least one of: below or up to X MHz or GHZ, above X MHz or GHz, between X and Y MHz or GHz, below or up to X THz, between X and Y THz, above X THz and the like. Furthermore, a WTRU may operate in a licensed band or an unlicensed band. A WTRU uses a medium procedure associated with either a licensed or an unlicensed operation (e.g., LBT for an unlicensed band). Furthermore, a WTRU receives one or more signals or channels in a frequency band. For purposes of this specification the terms band and range are used interchangeably. A licensed band is one type of band. An unlicensed band is another type of band.

A WTRU determines a band (e.g., frequency band), for example, based on receiving (e.g., successfully receiving) a signal, channel, or SSB in (or using) a frequency (e.g., a carrier) within a band in which it operates. The band may be for (e.g., for communication with) a cell, gNB, or TRP. The band may be for DL reception. The WTRU uses the band for DL reception and/or UL transmission. The WTRU may transmit or receive in the band. A WTRU determines a band type. For example, the WTRU may determine the band type is licensed or the WTRU may determine the band type is unlicensed.

In some embodiments the WTRU determines the band type by blind detection. In other embodiments the WTRU determines the band type by examining a bit or bits conveyed in the PBCH payload. For example, the WTRU determines the band type is unlicensed when it receives or detects an SSB or candidate SSB index at or above a certain value, e.g., 64. The WTRU determines the band is unlicensed when it detects or determines at least one of the N SSB/candidate SSB index bits to be 1.

A WTRU may determine the content of a MIB and/or the order of content of the MIB based on the band (e.g., the determined band) or band type (e.g., determined band type). The WTRU may receive a PBCH associated with a received SSB. The WTRU may determine the content of the PBCH payload (e.g., the content of the first and/or second set of PBCH payload bits), and/or the order of content of the PBCH payload (e.g., the order of the content of the first and/or second set of PBCH payload bits), based on the band or band type (e.g., the determined band or band type).

In an example, the MIB may contain a first number of SSB (or candidate SSB) index bits when the WTRU determines a first band (e.g., of operation) or band type and a second number of SSB (or candidate SSB) index bits when the WTRU determines a second band (e.g., of operation) or band type. The first number may be less than or equal to 6. The second number may be 7 or greater than 7. The first number may be L. The second number may be N+L. The N+L bits may be included in the first set of PBCH payload bits and ordered as described herein.

In an example, one or more operating parameters that may be used or present in the MIB (e.g., in the second set of PBCH payload bits) when operating in a first (e.g., lower) frequency band or with a first band type may not be used or present in the MIB when operating in a second (e.g., higher) frequency band or with a second band type. For example, a subcarrier spacing indication (e.g., subCarrierSpacingCommon) may be present in the MIB in a first frequency band and may not be present in the MIB in a second frequency band.

In another example, when operating in a first frequency band, there may be no SSB/candidate SSB index bits in the second set of PBCH payload bits. When operating in the second frequency band, there may be one or more SSB/candidate SSB index bits, for example N (e.g., the added N) SSB/candidate SSB index bits in the second set of PBCH payload bits. The SSB/candidate SSB index bits may be placed as the first operational parameter bits in the second set of PBCH payload bits (e.g., before the SFN bit) or may be placed elsewhere. For N=1, the added SSB/candidate SSB index bit may, for example, replace the bit used for the subcarrier spacing indication (subCarrierSpacingCommon).

One or more bits of other operational parameters may be used for one or more of the N SSB/candidate SSB index bits, for example when operating in the second (e.g., higher) frequency band. For example, one or more of the following bits may be used for an SSB/candidate SSB index bit (e.g., for the MSB of a 7-bit SSB/candidate SSB index: a bit (e.g., LSB or MSB) of ssb-SubcarrierOffset, and a bit (e.g., MSB or LSB) of controlResourceSetZero in pdcch-ConfigSIB1.

Some embodiments provide rate matching around the candidate SS/PBCH block positions. For example, a WTRU assumes it will receive the SS/PBCH blocks within a DBTW in a half-frame based on to higher layer parameters, e.g., ssb-PositionsInBurst in SIB. In that case the WTRU expects that in case of the overlap between the PDSCH resource mappings with PRBs containing candidate SS/PBCH block transmission resources, the resources may not be available for PDSCH transmission in the OFDM symbols that SS/PBCH block is transmitted.

Embodiments address that challenge by providing a WTRU that performs PDSCH rate matching for the candidate SS/PBCH block indexes within the DBTW in the corresponding half-frame. The WTRU performs PDSCH rate matching around the original candidate SS/PBCH block indexes in addition to the new candidate SS/PBCH block indexes corresponding to SS/PBCH block indexes. For example, the WTRU performs PDSCH rate matching around the candidate SS/PBCH block indexes within the gap slots in SS/PBCH block pattern Case D for 120 KHz SCS.

Other embodiments determine timing of an extended SSB index from number of repetitions for an SSB index. According to these solutions, the WTRU detects the presence of, or decodes a set of SSBs that have the same SSB index or a same specific pattern of SSB indexes and have a specific timing relationship. For example, a timing relationship is defined by SSBs with same SSB index positioned in consecutive time occasions for SSBs. The WTRU determines at least one of the following based on at least one property of such set of SSBs: a) the timing of the slot and/or half-frame; b) a slot index and/or SSB occasion within a slot where an SSB from the set is detected, c) an extended SSB index; and d) whether the SSB corresponds to an SSB transmitted because it was previously skipped due to LBT failure (as described in previous section).

The at least one property of the set of SSBs may be one or more of: a) the number of detected SSBs of same SSB index within a time window (e.g. within a certain number of slots), for example, the WTRU determines that the SSB corresponds to an extended SSB index (value 64 and above) in case 2 SSBs in consecutive occasions are detected with same SSB index; b) a time interval or number of SSB occasions between SSBs with same SSB index; c) the value of the at least one SSB index of the set; d) a specific pattern of SSBs of same or different SSB indexes, for example, a pattern could be [A B A B] or [A B C A] where A, B, C are SSB indexes; and e) a specific time offset between the time when the half-frame starts and the time where one of the following starts, i.e., the pattern of SSBs, the first SSB instance of a specific SSB index of the pattern.

Such specific time offset may be pre-defined, pre-configured, or signaled to the WTRU. For example, the WTRU infers the time offset based on a pre-defined set of candidates SSB positions within a half-frame for each extended SSB index according to one of the previously described solutions. For example, the WTRU detects two SSBs with SSB index 3 in consecutive occasions, e.g. within one slot. The WTRU further determines that such SSB corresponds to extended SSB index (63+3)=66 and corresponds to re-transmission of SSB index 3 that was skipped due to LBT failure. Such extended SSB index is associated with slot index 10 according to a pre-defined set of candidates SSB positions. The WTRU infers that the start of the half-frame is 9 slots earlier than the slot in which the first SSB with SSB index 3 is detected.

In another example, the WTRU detects two SSBs with SSB index 33 in consecutive positions/occasions. The WTRU further determines that such SSB corresponds to extended SSB index (63+33)=96 and corresponds to re-transmission of SSB index 33 that was skipped, e.g., due to LBT failure. Such extended SSB index is associated with slot index 29 according to a pre-defined set of candidates SSB positions. The WTRU infers that the start of the half-frame is 28 slots earlier than the slot in which the first SSB with SSB index 33 is detected.

Other embodiments detect and/or indicate SSB blocks that were missed, e.g., due to LBT failures, and will be retransmitted. In an example implementation, a WTRU determines one or more possible modes of operation. For example, a first possible mode of operation is one in which no missing SSB detection and SSB retransmission correspond to additional candidate positions. For example, the WTRU blindly detects and measures based on a first number of SSBs (e.g., less than or equal to 64) and a first group of SSB resources. A second possible mode of operation is one in which SSB transmission occurs in additional candidate positions for increased number of SSBs, e.g., number of transmitted SSBs increases from 64 SSBs to 80 SSBs. The WTRU blindly detects and measures based on a second number of SSBs (e.g., number larger than 64 and less than or equal to 80) and the first group of SSB resources and a second group of SSB resources

A third possible mode of operation is one in which SSB transmission or retransmission occurs in additional candidate positions for missed SSBs. For example, the WTRU blindly detects and measures based on a first number of SSBs and the first group of SSB resources. If the WTRU determines one or more SSB blocks are missing, the WTRU tries to measure and blindly detect the missing SSB resources in the second group of SSB resources.

In one implementation, the WTRU determines the one or more modes of operation based on one or more of: Band type, Frequency range (FR), explicit indication received from a gNB, and WTRU blind detection. For Band type, in the event a band type for the operation is a first band type (e.g., licensed), then the WTRU determines the first or the second mode of operation. In the event the band type for the operation is a second band type (e.g., unlicensed), then the WTRU may determine the second or the third mode of operation. Band type may be predetermined or indicated by a gNB, e.g., based on one or more of MIB, SIB and sync raster offset)

For determination of mode based on Frequency range (FR), in the event a FR type for the operation is a first FR (e.g., FR2-1), then the WTRU determines the first mode of operation. In the event the FR type for the operation is (e.g., FR2-2), then the WTRU determines the second or the third mode of operation.

For determination of mode based on Explicit indication from a gNB the WTRU receives an indication that specifies one or more modes of operation. The indication may be conveyed by one or more of a variety of mechanisms. A first mechanism is an MIB. For example, following MIB bits are used for the explicit indication: the subcarrierSpacingCommon in MIB; the LSB of ssb-SubcarrierOffset in MIB; the MSB of controlResourceSetZero in pdcch-ConfigSIB1 in MIB. Other mechanisms for explicit indication include one or more of reserved bits in the MIB, a SIB, a DCI (group specific or WTRU specific), a MAC CE, and an RRC.

In some implementations, a WTRU performs or participates in one or more of following operations to determine whether SSB blocks are missing: a) WTRU blind detection; b) WTRU measurement of one or more signals to determine whether SSB blocks are missing. For example, if measurement results of the one or more signals are less than (or equal to) a threshold, the WTRU determines one or more missing signals correspond to missing SSB blocks.

The threshold can be a predetermined value. Alternatively, the threshold can be indicated using one or more mechanisms. A first mechanism is an MIB. For example, the following MIB bits are used to explicitly indicate whether SSB blocks are missing: a) the subcarrierSpacingCommon in MIB; b) the LSB of ssb-SubcarrierOffset in MIB; c) The MSB of controlResourceSetZero in pdcch-ConfigSIB1 in MIB; d) one or more of reserved bits in MIB; e) an SIB; f) a DCI (group specific or WTRU specific); f) a MAC CE; g) an RRC; and h) reception of some other indication from the gNB.

In some embodiments, the WTRU receives an indication from the gNB as to whether SSB blocks are missing. If SSB blocks are not indicated as missing, then the WTRU does not measure/detect the SSB blocks in the second group of SSB resources. If the SSB blocks are indicated as missing, the WTRU measures measures/detects the missing SSB blocks in the second group of SSB resources.

In an implementation, the WTRU may determine whether SSB blocks are missing based on WTRU blind detection and reception of gNB indication. For example, the WTRU may measure one or more signals. If measurement results of the one or more signals are less than (or equal to) a threshold, the WTRU may try to detect gNB indication in a configured/indicated DL resource. If the WTRU detects the gNB indication indicating the SSB blocks are missing, then the WTRU may determine to measure/detect the SSB blocks in the second group of SSB resources

In some embodiments an SSB pattern extends the number of SSB candidate indexes. A WTRU expects to receive missed SS/PBCH blocks in new candidate SS/PBCH block positions within the gap slots in half-frame, whereby WTRU receives the missed SS/PBCH blocks. For example, in some implementations there are eight gap slots, each including two candidate SS/PBCH block positions, which implies a total of 16 candidate SS/PBCH block positions in SS/PBCH block pattern Case D for 120 KHz SCS.

A WTRU expects to receive the CORESET #0 corresponding to the received SS/PBCH block based on controlResourceSetZero in pdcch-ConfigSIB1 in MIB, including the frequency offset, number of RBs, number of symbols and multiplexing patterns of the CORESET #0. While multiplexing pattern 1 indicates a TDM multiplexing of an SS/PBCH block and the corresponding CORESET #0, the multiplexing patterns 2 and 3 are FDM multiplexing of an SS/PBCH block and the corresponding CORESET #0.

In an implementation, the WTRU determines that the SS/PBCH block pattern in the gap slots differs from the original SS/PBCH block pattern, e.g., Case D for 120 KHz SCS. For example, each gap slot includes 3 candidate SS/PBCH block positions. The first 2 symbols in each gap slot are reserved for CORESET reception or uplink transmission. The three candidate SS/PBCH block positions may be consecutive in time, occupying the remaining 12 symbols.

The first symbol of candidate SS/PBCH blocks may have indexes {2, 6, 10, 16, 20, 24}+28n, wherein n=4, 9, 14, 19, and wherein index 0 in the candidate SS/PBCH blocks indexes corresponds to the first symbol of the first slot within a half-frame. The multiplexing patterns 2 and 3 can be used for multiplexing of an SS/PBCH block and the corresponding CORESET #0.

In another example, the pairs of 2 gap slots include 7 candidate SS/PBCH block positions in total. The seven candidate SS/PBCH block positions are, e.g., consecutive in time, occupying all 28 symbols. The first symbol of candidate SS/PBCH blocks have indexes {0, 4, 8, 12, 16, 20, 24, 28}+28n, wherein n=4, 9, 14, 19, and wherein index 0 for the candidate SS/PBCH blocks indexes corresponds to the first symbol of the first slot within a half-frame. The multiplexing patterns 2 and 3 may be used for multiplexing of an SS/PBCH block and the corresponding CORESET #0.

Alternatively, the WTRU determines an association between candidate SS/PBCH block positions and missing SS/PBCH blocks based on prioritization or a hybrid positioning of prioritized SS/PBCH blocks based on “first missed-first served” as discussed in above.

In some implementations a WTRU monitors, receives, or attempts to decode a search space for SIB reception, wherein the search space is the first PDCCH search space (e.g., Type0-PDCCH) monitored after SS/PBCH block reception. A DCI format (e.g., DCI format 1_0) monitored in the first PDCCH search space includes, e.g., at least one field that includes reserved bits that match the DCI format size with another DCI format (e.g., DCI format 0_0).

A DCI format (e.g., DCI format 1_0) size may depend on the use case of the frequency resource in which a WTRU monitors the DCI format. The use case may include at least one of spectrum characteristics (e.g., shared spectrum or not), link types (e.g., Uu or sidelink), presence of channel (e.g., DBTW is on or off), and network types (e.g., TN or NTN). For example, a WTRU may monitor a DCI format with a first DCI format size in a shared spectrum and the WTRU may monitor the DCI format with a second DCI format size in a non-shared spectrum (e.g., licensed spectrum).

In a frequency band, a WTRU may not have information about the use case of the frequency resource. In that case the WTRU may need to blindly detect a DCI format which may have different sizes based on the use case of the frequency resource. To address this case, a DCI format size is determined based on a frequency range (FR), wherein the frequency range may include frequency bands within a certain frequency spectrum. For example, a first FR (FR1) may include frequency bands up to 7.125 GHZ, a second FR (FR2-1) may include frequency bands from 7.125 GHz to 52.6 GHZ, a third FR (FR2-2) may include frequency bands from 52.6 GHz to 71 GHz.

In an embodiment a WTRU monitors a DCI format according to a first DCI format size in FR1 and FR2-1, and the WTRU monitors a DCI format according to a second DCI format size in FR2-2. A WTRU determines a DCI format size (e.g., DCI format 1_0) based on the FR in which the WTRU monitors the associated DCI format. The term ‘DCI format size’ is used interchangeably used with the terms ‘DCI content size’, ‘DCI bit field size’, ‘reserved bit size’, ‘number of reserved bits in DCI’, ‘dummy bits in DCI’, ‘DCI size matching bit size’, and ‘zero padding bits’ while remaining consistent with the embodiments as described herein.

In another implementation, a DCI format size is determined based on use case of the frequency resource and/or FR. For example, a first DCI format size is used for a first use case (e.g., shared spectrum) in a first FR (e.g., FR1) and a second DCI format size is used for the first use case (e.g., shared spectrum) in a second FR (e.g., FR2). One or more of following may apply. In a first FR (e.g., FR1, FR2-1), the use case of frequency resource determines the DCI format size. In a second FR (e.g., FR2-2), the use case of frequency resource may not change the DCI format size.

In an implementation, RNTI of a DCI format (e.g., DCI format 1_0) indicates use case of the frequency resource. For example, a first RNTI is used for a DCI format when the frequency resource is used for a first spectrum characteristic (e.g., shared spectrum) and a second RNTI is used for a DCI format when the frequency resource is used for a second spectrum characteristic (e.g., non-shared spectrum). One or more of following may apply. The first RNTI is a first SI-RNTI (e.g., SI-RNTI-1) associated with a shared spectrum and the second RNTI is a second SI-RNTI (e.g., SI-RNTI-2) associated with a non-shared spectrum.

A WTRU determines the spectrum characteristic based on the RNTI received, detected, or decoded in a DCI format (e.g., DCI format 1_0) and the WTRU performs subsequent transmission/reception based on the determined spectrum characteristics. For example, a WTRU performs LBT if the WTRU determined the frequency resource for transmission is within a shared portion of the spectrum. Otherwise, the WTRU transmits without performing LBT. A WTRU receives DBTW if the WTRU determined the frequency resource is within a shared portion of the spectrum.

In another implementation, RNTI of a DCI format (e.g., DCI format 1_0) indicates presence of a signal (e.g., DBTW) in the frequency band. For example, a WTRU determines to receive DBTW if a first RNTI is received in a DCI format (e.g., DCI format 1_0) in a search space (e.g., Type0-PDCCH). In another implementation, RNTI of a DCI format (e.g., DCI format 1_0) indicates the use of functionality (e.g., LBT) for a UL transmission. For example, a WTRU determines whether the WTRU performs LBT before a UL transmission or not based on the RNTI received in a DCI format in a search space (e.g., Type0-PDCCH). If the WTRU received a first RNTI (e.g., SI-RNTI-1), the WTRU performs LBT before a UL transmission; if the WTRU received a second RNTI (e.g., SI-RNTI-2), the WTRU transmits a UL signal without LBT.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed by a wireless transmit receive unit for receiving synchronization signal block (SSB); the method comprising:
receiving a candidate SSB in a set of symbols in a slot;
receiving an indication of a mode of association between candidate SSB positions and candidate SSB index;
determining a candidate SSB index associated with the candidate SSB;
determining a symbol number of a symbol in the set of symbols and a slot number of the slot based on the candidate SSB index and the indicated mode of association; and
receiving a PDCCH transmission using a timing determined based on the determined symbol number and slot number.

2. The method of claim 1, wherein the indicated mode of association is either a first mode or a second mode.

3. The method of claim 3, wherein the slot number is a first slot number when the mode of association is the first mode of association, and the slot number is a second slot number when the mode of association is the second mode of association.

4. The method of claim 1 wherein the mode of association is a prioritization mode, where SSBs at the beginning of each SSB candidate bundle are prioritized.

5. The method of claim 1 wherein the mode of association is a hybrid model based on priority and first missed-first served.

6. The method of claim 1 wherein the indication is received in a master information block (MIB).

7. A wireless transmit receive unit (WTRU) configured to receive synchronization signal block (SSB), the WTRU comprising:
a processor; and
a transceiver, wherein the processor and transceiver are configured to:
receive a candidate SSB in a set of symbols in a slot;
receive an indication of a mode of association between candidate SSB positions and candidate SSB index;
determine a candidate SSB index associated with the candidate SSB;
determine a symbol number of a symbol in the set of symbols and a slot number of the slot based on the candidate SSB index and the indicated mode of association; and
receive a physical downlink control channel (PDCCH) transmission using a timing determined based on the determined symbol number and slot number.

8. The WTRU of claim 7, wherein the indicated mode of association is either a first mode or a second mode.

9. The WTRU of claim 8, wherein the slot number is a first slot number when the mode of association is the first mode of association, and the slot number is a second slot number when the mode of association is the second mode of association.

10. The WTRU of claim 7, wherein the mode of association is a prioritization mode, where SSBs at the beginning of each SSB candidate bundle are prioritized.

11. The WTRU of claim 7, wherein the mode of association is a hybrid model based on priority and first missed-first served.

12. The WTRU of claim 7, wherein the indication is received in a master information block (MIB).
